(19) United States
(12) Patent Application Publication
(10) Pub. No.: US 2025/0119829 A1
(43) Pub. Date: Apr. 10, 2025

(54) MULTI-HOP SUPPORT FOR COORDINATED MEDIUM ACCESS

(71) Applicant: QUALCOMM Incorporated, San Diego, CA (US)

(72) Inventors: Abdel Karim AJAMI, San Diego, CA (US); George CHERIAN, San Diego, CA (US); Alfred ASTERJADHI, San Diego, CA (US); Abhishek Pramod PATIL, San Diego, CA (US); Sai Yiu Duncan HO, San Diego, CA (US); Gaurang NAIK, San Diego, CA (US); Yanjun SUN, San Diego, CA (US); Xiaolong HUANG, Santee, CA (US)

(21) Appl. No.: 18/482,808

(22) Filed: Oct. 6, 2023

(51) Int. Cl. H04W 52/02

(52) U.S. Cl. CPC H04W 52/0216

(57) ABSTRACT

This disclosure provides methods, components, devices and systems for multi-hop support for coordinated medium access. Some aspects more specifically relate to one or more mechanisms according to which an access point (AP) may indicate how many hops a medium access schedule is to be re-announced throughout a wireless network. In some examples, a first AP may select a medium access schedule and may transmit timing information indicative of communication periods associated with the medium access schedule and a value associated with a multi-hop propagation of the timing information. A second AP may receive the timing information and the value and may selectively transmit the timing information in accordance with the value. For example, if the value is indicative of greater than or equal to a threshold hop count value, the second AP may propagate the timing information associated with the communication periods of the first AP.

### TECHNICAL FIELD

This disclosure relates to wireless communication and, more specifically, to multi-hop support for coordinated medium access.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a first wireless access point (AP). The first wireless AP may include a processing system that includes processor circuitry and memory circuitry that stores code. The processing system may be configured to cause the first wireless AP to receive, via one or more frames, timing information associated with communication periods of a second wireless AP and a value associated with a multi-hop propagation of the timing information and selectively transmit, via a frame of the first wireless AP, the timing information associated with the communication periods of the second wireless AP in accordance with the value.

Another innovative aspect of the subject matter described in this disclosure can be implemented in a method for wireless communication by a first wireless AP. The method may include receiving, via one or more frames, timing information associated with communication periods of a second wireless AP and a value associated with a multi-hop propagation of the timing information and selectively transmitting, via a frame of the first wireless AP, the timing information associated with the communication periods of the second wireless AP in accordance with the value.

Another innovative aspect of the subject matter described in this disclosure can be implemented in a first wireless AP. The first wireless AP may include means for receiving, via one or more frames, timing information associated with communication periods of a second wireless AP and a value associated with a multi-hop propagation of the timing information and means for selectively transmitting, via a frame of the first wireless AP, the timing information associated with the communication periods of the second wireless AP in accordance with the value.

Another innovative aspect of the subject matter described in this disclosure can be implemented in a non-transitory computer-readable medium storing code for wireless communication by a first wireless AP. The code may include instructions executable by a processor to receive, via one or more frames, timing information associated with communication periods of a second wireless AP and a value associated with a multi-hop propagation of the timing information and selectively transmit, via a frame of the first wireless AP, the timing information associated with the communication periods of the second wireless AP in accordance with the value.

In some examples of the method, first wireless APs, and non-transitory computer-readable medium described herein, receiving the value associated with the multi-hop propagation of the timing information may include operations, features, means, or instructions for receiving the value via a broadcast target wake time (TWT) identifier (ID) field.

In some examples of the method, first wireless APs, and non-transitory computer-readable medium described herein, the broadcast TWT ID field may be associated with the value in accordance with a TWT schedule information subfield being set to a second value.

In some examples of the method, first wireless APs, and non-transitory computer-readable medium described herein, receiving the value associated with the multi-hop propagation of the timing information may include operations, features, means, or instructions for receiving the value via a hop count field of a frame or element dedicated to conveying information associated with the multi-hop propagation of the timing information.

In some examples of the method, first wireless APs, and non-transitory computer-readable medium described herein, selectively transmitting the timing information may include operations, features, means, or instructions for transmitting the timing information in association with the value indicating that the first wireless AP may be to propagate the timing information.

Some examples of the method, first wireless APs, and non-transitory computer-readable medium described herein may further include operations, features, means, or instructions for transmitting an updated value in association with transmitting the timing information via the frame of the first wireless AP, where the updated value may be associated with an increment or a decrement of the value.

Another innovative aspect of the subject matter described in this disclosure can be implemented in a first wireless AP. The first wireless AP may include a processing system that includes processor circuitry and memory circuitry that stores code. The processing system may be configured to cause the first wireless AP to generate one or more frames to include timing information associated with communication periods of the first wireless AP and a value associated with a multi-hop propagation of the timing information and transmit, via the one or more frames, the timing information and the value associated with the multi-hop propagation of the timing information.

Another innovative aspect of the subject matter described in this disclosure can be implemented in a method for wireless communication by a first wireless AP. The method may include generating one or more frames to include timing information associated with communication periods of the first wireless AP and a value associated with a multi-hop propagation of the timing information and transmitting, via the one or more frames, the timing information and the value associated with the multi-hop propagation of the timing information.

Another innovative aspect of the subject matter described in this disclosure can be implemented in a first wireless AP. The first wireless AP may include means for generating one or more frames to include timing information associated with communication periods of the first wireless AP and a value associated with a multi-hop propagation of the timing information and means for transmitting, via the one or more frames, the timing information and the value associated with the multi-hop propagation of the timing information.

Another innovative aspect of the subject matter described in this disclosure can be implemented in a non-transitory computer-readable medium storing code for wireless communication by a first wireless AP. The code may include instructions executable by a processor to generate one or more frames to include timing information associated with communication periods of the first wireless AP and a value associated with a multi-hop propagation of the timing information and transmit, via the one or more frames, the timing information and the value associated with the multi-hop propagation of the timing information.

In some examples of the method, first wireless APs, and non-transitory computer-readable medium described herein, transmitting the value associated with the multi-hop propagation of the timing information may include operations, features, means, or instructions for transmitting the value via a broadcast TWT ID field.

In some examples of the method, first wireless APs, and non-transitory computer-readable medium described herein, the broadcast TWT ID field may be associated with the value in accordance with a TWT schedule information subfield being set to a second value.

In some examples of the method, first wireless APs, and non-transitory computer-readable medium described herein, transmitting the value associated with the multi-hop propagation of the timing information may include operations, features, means, or instructions for transmitting the value via a hop count field of a frame or element dedicated to conveying information associated with the multi-hop propagation of the timing information.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example signaling diagram that supports multi-hop support for coordinated medium access.

FIGS. 3 and 4 show example frames that support multi-hop support for coordinated medium access.

FIG. 5 shows an example process flow that supports multi-hop support for coordinated medium access.

FIG. 6 shows a block diagram of an example wireless communication device that supports multi-hop support for coordinated medium access.

FIGS. 7-10 show flowcharts illustrating example processes performable by or at a first wireless access point (AP) that supports multi-hop support for coordinated medium access.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to multi-hop access point (AP) coordination. Some aspects more specifically relate to one or more configuration- or signaling-based mechanisms according to which an AP may indicate how many hops a medium access schedule is to be (re-)announced throughout a wireless network. In some examples, a first AP may select (such as identify, configure, ascertain, negotiate, or otherwise determine) a medium access schedule and may transmit timing information indicative of communication periods associated with the medium access schedule and a value associated with a multi-hop propagation of the timing information. Such a value may be associated with (such as implicitly or explicitly indicative of) a hop count associated with the multi-hop propagation of the timing information. In some implementations, the first AP may transmit the value via a broadcast target wake time (TWT) identifier (ID) field of a TWT element. In some other implementations, the first AP may transmit the value via a frame or element that is dedicated to (such as by function or configuration) conveying information associated with the multi-hop propagation of the timing information.

A second AP may receive the timing information and the value associated with the multi-hop propagation of the timing information and may selectively transmit (such as re-announce, propagate, or forward) the timing information in accordance with the value. For example, if the value is indicative of a first hop count value, the second AP may refrain from propagating the timing information associated with the communication periods of the first AP. Alternatively, if the value is indicative of a second hop count value or greater, the second AP may propagate the timing information associated with the communication periods of the first AP. In examples in which the second AP propagates the timing information associated with the communication periods of the first AP, the second AP may transmit an updated value associated with the multi-hop propagation of the timing information, with such an updated value being associated with an increment or a decrement to the received value (such that the updated value may be implicitly or explicitly indicative of an updated hop count).

Particular aspects of the subject matter described in this disclosure can be implemented to realize one or more of the following potential advantages. In some examples, by conveying timing information indicative of a medium access schedule and a value indicative of a multi-hop propagation of that timing information throughout a wireless network, a first AP within the wireless network may share knowledge of one or more medium access schedules with one or more other APs within the wireless network that are more than one hop away, which may facilitate more robust and reliable coordinated medium access by enabling medium access coordination among more APs, including APs that might not be able to directly receive from the first AP. Such more robust and reliable coordinated medium access may reduce or limit interference between different basic service sets (BSSs), which may result in fewer communication errors, fewer retransmissions, and power savings associated with fewer retransmissions. Further, by flexibly or dynamically setting (such as selecting, configuring, or toggling) the value associated with the multi-hop propagation, an AP may have greater control over how many hops a medium access schedule of the AP is propagated, which the AP may use to balance interference avoidance with overall system data rates. As such, an AP may implement the subject matter described in this disclosure to balance reliability and overall data rates by, for example, triggering a greater propagation of timing information of a medium access schedule associated with high priority traffic as compared to timing information of a medium access schedule associated with low priority traffic. Moreover, in accordance with the signaling mechanisms described herein, an AP may convey such a value associated with multi-hop propagation with limited or otherwise efficient signaling overhead, which may further support greater spectral efficiency, higher data rates, and greater system capacity.

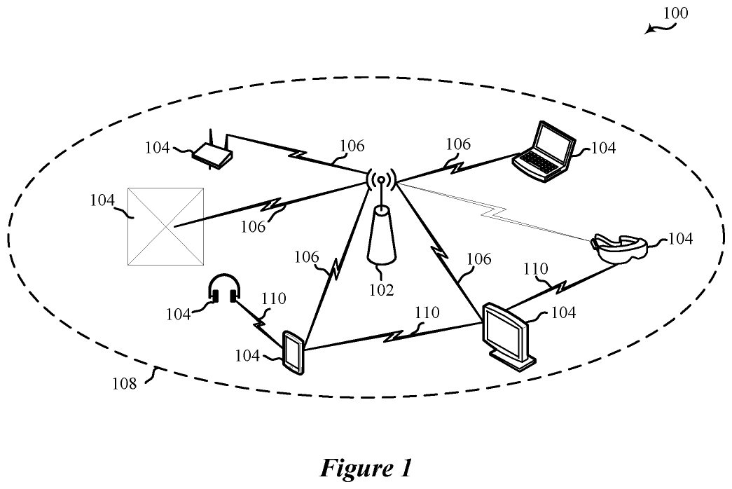

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and then contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of wireless communication network 100 in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may then be allocated resources during the TXOP as described above.

In some aspects, one or more wireless communication devices (such as one or more APs 102 or one or more STAs 104, or any combination thereof) of the wireless communication network 100 may employ techniques associated with coordinated medium access. Such one or more wireless communication devices may employ coordinated medium access techniques to support use cases associated with stringent latency requirements (such as latency requirements, which may be understood as latency targets, of less than 10 milliseconds). In some implementations, coordinated medium access may improve the reliability of the wireless communication network 100 in terms of latency and throughput by increasing a quantity of chances (such as opportunities) for APs 102 to listen to transmissions of other APs 102 and by enabling greater coordination among APs 102. Coordinated medium access may refer to any type of medium access scheme associated with coordination among multiple different wireless communication devices, including schemes associated with different medium access schedules at different APs 102. For example, coordinated medium access may include medium access via coordinated TWT, such as restricted TWT (R-TWT). As described herein, a medium access schedule (such as a coordinated medium access schedule) may include or refer to a coordinated TWT schedule, such as an R-TWT schedule, and may be associated with one or more communication periods.

During or as part of coordinated medium access, an AP 102 may announce timing information associated with a medium access schedule. Such timing information may include information indicative of one or more time epochs, one or more service periods (SPs), a periodicity, a duration, or any combination thereof. For example, an AP 102 may announce the time epochs or other scheduling information corresponding to a TWT or R-TWT schedule or stream classification service (SCS) agreement SPs within a BSS of that AP 102. In such examples, the timing information may include information indicative of one or more SPs corresponding to a co-hosted AP 102 or an AP 102 that corresponds to a non-transmitted BSS identifier (BSSID) in a multiple BSSID (MBSSID) set. Additionally, or alternatively, an AP 102 may announce the time epochs or other scheduling information corresponding to one or more SPs or schedules corresponding to one or more other friendly APs 102. “Friendly” APs 102 may be understood as or refer to APs 102 that coordinate medium access with each other or that honor (such as respect, and refrain from communicating during) each other's medium access schedules, or both. Additionally, or alternatively, an AP 102 may announce the time epochs or other scheduling information corresponding to one or more SPs or schedules corresponding to one or more other non-friendly APs 102. “Non-friendly” APs 102 may be understood as or refer to APs 102 that do not coordinate medium access with each other or that do not honor (such as do not respect, and potentially communicate during) each other's medium access schedules, or both.

An AP 102 may announce (which may be understood as transmitting, such as broadcasting, via one or more frames) one or more medium access schedules such that the one or more medium access schedules are received by associated STAs 104 that may be expected to follow rules (such as channel access rules) related to coordinated medium access and friendly APs 102 that may be expected to follow the rules (such as the channel access rules) and also announce the one or more medium access schedules to other friendly APs 102. For example, an AP 102 may use one or more frames or one or more elements associated with providing information related to an R-TWT schedule to inform STAs 104 associated with the AP 102 of one or more medium access schedules of one or more other APs 102. Rules related to coordinated medium access may include channel access rules (such as TXOP termination rules) and one or more additional rules, such as traffic delivery rules or membership setup rules.

In some aspects, such announcements by an AP 102 may be transmitted via one or more management frames, such as one or more Beacon frames, one or more Probe Response frames, one or more Association Response frames, one or more fast initial link setup (FILS) Discovery frames, one or more broadcast frames that follow the beacon frame, one or more other management frames, or any combination thereof. In some aspects, information may be carried in a follow-up frame, such as a broadcast frame that follows a Beacon frame, to reduce how much information is carried by an initial frame (such as the frame that the follow-up frame succeeds or follows in time). For example, a broadcast follow-up frame may be used to offload information from a Beacon frame. In some examples, an AP 102 may transmit such a broadcast follow-up frame to carry (such as include or indicate) information that is applicable to a specific generation of devices. Such a specific generation of devices may refer to APs 102 or STAs 104, or both, associated with a specific set of capabilities, APs 102 or STAs 104, or both, associated with a specific amendment of an 802.11 standard, or APs 102 or STAs 104, or both, that are otherwise expected to be able to receive and parse information that other (such as lower generation or less capable) devices are unable to receive or parse. Accordingly, such an offloading mechanism that leverages a broadcast follow-up frame may help preserve backward compatibility of existing frames, such as existing Beacon frames (such that legacy STAs 104 may be able to discover one or more APs 102 and gather information related to the one or more APs 102), while STAs 104 belonging to the specific generation may gather additional information about one or more APs 102 via the follow-up frame (which legacy STAs 104 may discard, ignore, or drop in accordance with their relatively lower device capability).

In some systems, an AP 102 may be expected to announce medium access schedules of a first hop neighbor AP 102 to provide protection, but such an announcement of medium access schedules of a first hop neighbor AP 102 may be insufficient in some deployment scenarios. For example, due to obstacles or other obstructions, movement, reliability or interference targets, or changing network conditions, not all friendly APs 102 may be in range of an announcing AP 102. Further, in some scenarios, an AP 102 may not be able to receive a Beacon frame of a friendly AP 102 even if the AP 102 is within the transmission range of the friendly AP 102. Such scenarios may include, for example, scenarios in which an ongoing uplink or downlink transmission overlaps with the Beacon frame transmission by the friendly AP 102. A harmful (in terms of interference) overlap of SPs between otherwise friendly APs 102 may occur in accordance with (as a result of) such failures to sufficiently or reliably provide information indicative of medium access schedules throughout a wireless network, which may result in relatively high interference levels and an increase in communication errors.

In some implementations, one or more APs 102 of the wireless communication network 100 may increase a likelihood of medium access schedules (including R-TWT schedules or other communication periods) to be propagated a sufficient quantity of hops throughout the wireless communication network 100 in accordance with transmitting a value associated with a multi-hop propagation of timing information associated with a medium access schedule. Such a value may be implicitly or explicitly indicative of, and may accordingly be understood or referred to as, a hop count or a hop count value. As such, an AP 102 may set (such as identify, select, configure, or otherwise determine) the value associated with the multi-hop propagation to inform other APs 102 within the wireless communication network 100 of how many times a corresponding medium access schedule is to be (re-)announced throughout the wireless communication network 100.

For example, an AP 102 may use the value associated with the multi-hop propagation to indicate that a corresponding schedule is to be re-announced (such as propagated or forwarded) one more time, two more times, three more times, four more times, and so on. As such, a value associated with multi-hop propagation may indicate that a corresponding schedule is to be re-announced a single time or multiple times, and in either scenario such a value may still be understood as being associated with multi-hop propagation in accordance with such an ability of an AP 102 to use such a value to indicate potentially multiple hops. Additionally, or alternatively, an AP 102 may use a value associated with single-hop propagation to indicate that a corresponding schedule is to be re-announced (such as propagated or forwarded) one more time. Such a value associated with single-hop propagation may be a flag or another type of one-bit indicator, indicating, for example, propagation or no propagation for a corresponding schedule. As such, an AP 102 may support a value associated with multi-hop propagation, a value associated with single-hop propagation, or a value associated with a propagation of one or multiple hops to enable an owner AP 102 to efficiency convey propagation information associated with a medium access schedule. Such APs 102 may further support one or more signaling- or functionality-based (such as configuration-based) mechanisms related to multi-hop coordinated medium access support for reliable schedule distribution among APs 102 within the wireless communication network 100.

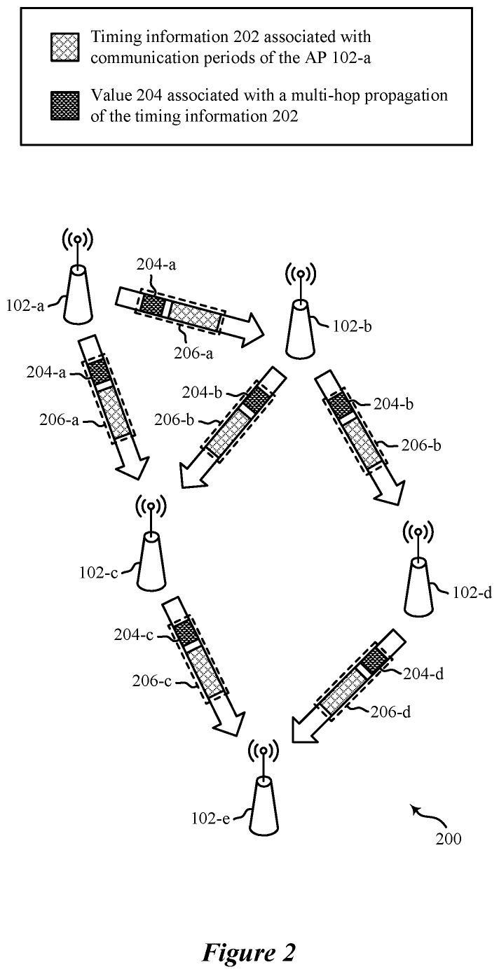

FIG. 2 shows an example signaling diagram 200 that supports multi-hop support for coordinated medium access. The signaling diagram 200 may implement or be implemented to realize aspects of the wireless communication network 100. For example, the signaling diagram 200 may illustrate communication between APs 102 within a wireless network, including an AP 102-a, an AP 102-b, an AP 102-c, an AP 102-d, and an AP 102-e. In some aspects, each of the AP 102-a, the AP 102-b, the AP 102-c, the AP 102-d, and the AP 102-e may be an example of an AP 102 as illustrated by and described with reference to FIG. 1.

In some implementations, each AP 102 (such as any one of the AP 102-a, the AP 102-b, the AP 102-c, the AP 102-d, and the AP 102-e) may support one or more signaling- or functionality-based mechanisms associated with propagating medium access schedules of other, physically separated APs 102 a sufficient quantity of hops throughout a wireless network. In other words, each AP 102 may support one or more rules or signaling mechanisms to enable that AP 102 to indicate how many hops a schedule is expected to be (re-)announced and, in some implementations, to indicate which other APs 102 are expected to follow one or more corresponding rules. For example, each AP 102 may announce a quantity of hops for which a medium access schedule (such as R-TWT SPs) of that AP 102 is expected to be honored and re-announced by other (friendly) APs 102.

For example, the AP 102-a may select (such as identify, configure, ascertain, negotiate, obtain an indication of, or otherwise determine) a medium access schedule and may transmit (such as broadcast) timing information 202 indicative of the medium access schedule. In some aspects, the medium access schedule may be associated with a set of one or more communication periods (such as SPs). As such, the AP 102-a may be equivalently understood as transmitting (such as broadcasting) timing information 202 associated with the communication periods of the AP 102-a. In some implementations, the AP 102-a may transmit a value 204 associated with a multi-hop propagation of the timing information 202. The value 204 may be associated with a hop count (such as a hop count value) and may be indicative of a quantity of hops for which the timing information 202 is expected to be honored and re-announced by other (friendly) APs 102. As such, the value 204 may be updated (such as incremented or decremented) by each propagating AP 102 until the requested quantity of hops is reached (such as satisfied).

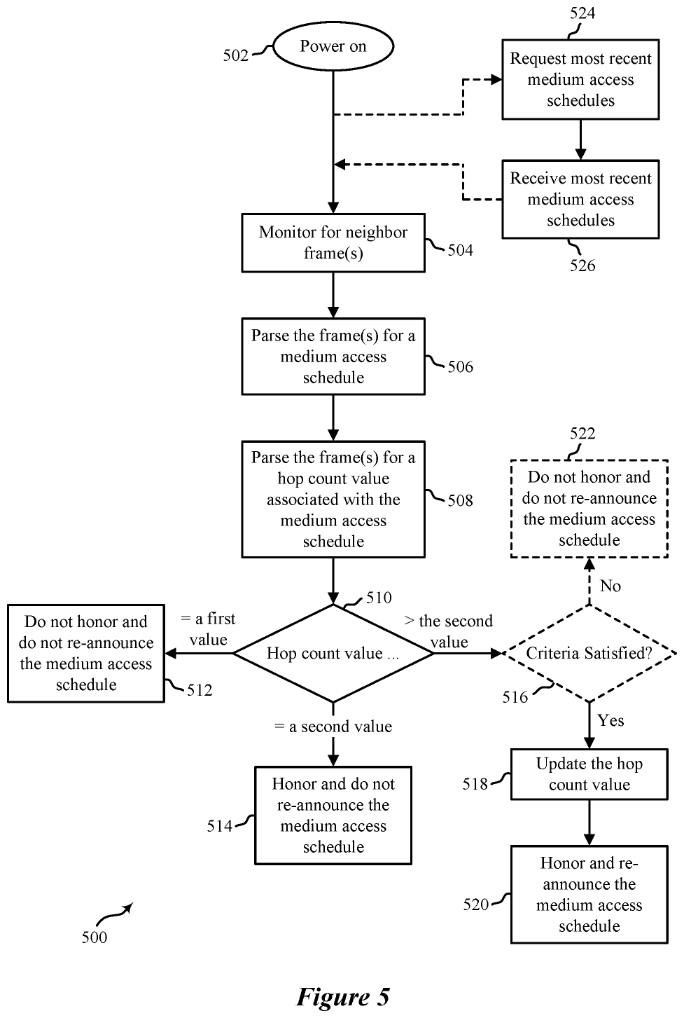

For example, the AP 102-a may transmit the timing information 202 and an initial value 204-a. In some aspects, the AP 102-a may transmit the timing information 202 and the initial value 204-a via one or more frames 206-a, which may be one or more management frames. The AP 102-a may include the timing information 202 and the initial value 204-a in a single frame, or may separate the timing information 202 and the initial value 204-a across multiple frames. In accordance with the AP 102-a transmitting (such as broadcasting) the timing information 202 and the initial value 204-a via one or more frames 206-a, the AP 102-b may receive the timing information 202 and the initial value 204-a. The AP 102-b may parse (such as decode or process) the one or more frames 206-a and may selectively propagate (such as re-announce, relay, or forward) the timing information 202 of the AP 102-a in accordance with the initial value 204-a. In other words, the AP 102-b may select (such as ascertain or otherwise determine) whether to include the timing information 202 of the AP 102-a in one or more frames for further transmission (such as for further propagation or re-announcement throughout the wireless network) depending on the initial value 204-a. In some aspects, the AP 102-b may select whether to propagate the timing information 202 in accordance with the process flow 500, as illustrated by and described with reference to FIG. 5.

In some implementations, and in accordance with the example of the signaling diagram 200, the AP 102-b may select to further propagate the timing information 202 in accordance with the initial value 204-a. In such implementations, the AP 102-b may update the initial value 204-a and may transmit an updated version of the initial value 204-a in association with propagating the timing information 202. For example, the AP 102-b may transmit the timing information 202 and an updated value 204-b via one or more frames 206-b, which may be one or more management frames. The AP 102-b may include the timing information 202 and the updated value 204-b in a single frame, or may separate the timing information 202 and the updated value 204-b across multiple frames.

In some scenarios, the AP 102-c may receive both the one or more frames 206-a and the one or more frames 206-b. As such, the AP 102-c may receive the timing information 202 associated with a same schedule (such as a same set of communication periods) from two different APs 102 (such that different hop counts may be received for the same schedule). In such scenarios, the AP 102-c may use a configured rule or a signaled indication, or a combination thereof, to select whether to use the initial value 204-a or the updated value 204-b as part of determining whether to propagate the timing information 202.

In some implementations, the AP 102-c may receive an indication to use, or otherwise determine (such as in accordance with a configured rule) to use, a relatively higher value of the initial value 204-a and the updated value 204-b (such as to facilitate extra or more reliable medium access protection). In such implementations, the AP 102-c may use the initial value 204-a to determine whether to propagate the timing information 202. In some other implementations, the AP 102-c may receive an indication to use, or otherwise determine (such as in accordance with a configured rule) to use, a relatively lower value of the initial value 204-a and the updated value 204-b (such as to facilitate more conservative medium access protection). In such implementations, the AP 102-c may use the updated value 204-b to determine whether to propagate the timing information 202. In some other implementations, the AP 102-c may receive an indication or otherwise determine that, if an owner AP announcement is received (such as an announcement directly from the AP 102-a), other re-announcements of the same schedule may be ignored. In such implementations, the AP 102-c may use the initial value 204-a to determine whether to propagate the timing information 202 (as the initial value 204-a is received via the one or more frames 206-a that are received from the AP 102-a, which may be understood as the owner AP).

In examples in which the AP 102-c propagates the timing information 202 (which the AP 102-c may select to do in accordance with the process flow 500, as illustrated by and described with reference to FIG. 5), the AP 102-c may transmit the timing information 202 and an updated value 204-c via one or more frames 206-c, which may be one or more management frames. The AP 102-c may include the timing information 202 and the updated value 204-c in a single frame, or may separate the timing information 202 and the updated value 204-c across multiple frames. The updated value 204-c may be an updated version of the initial value 204-a (if the initial value 204-a was used in the determination of whether to propagate the timing information 202) or an updated version of the updated value 204-b (if the updated value 204-b was used in the determination of whether to propagate the timing information 202).

The AP 102-d may receive the one or more frames 206-b from the AP 102-b and may selectively propagate (such as relay or forward) the timing information 202 of the AP 102-a in accordance with the updated value 204-b. In other words, the AP 102-d may select (such as ascertain or otherwise determine) whether to include the timing information 202 of the AP 102-a in one or more frames for further transmission (such as for further propagation or re-announcement throughout the wireless network) depending on the updated value 204-b. In some aspects, the AP 102-d may select whether to propagate the timing information 202 in accordance with the process flow 500, as illustrated by and described with reference to FIG. 5.

The AP 102-e may receive one or both of the one or more frames 206-c or the one or more frames 206-d and may selectively propagate (such as relay or forward) the timing information 202 of the AP 102-a in accordance with one of the updated value 204-c or the updated value 204-d. In other words, the AP 102-e may select (such as ascertain or otherwise determine) whether to include the timing information 202 of the AP 102-a in one or more frames for further transmission (such as for further propagation or re-announcement throughout the wireless network) depending on the updated value 204-c or the updated value 204-d. In some aspects, the AP 102-e may select whether to propagate the timing information 202 in accordance with the process flow 500, as illustrated by and described with reference to FIG. 5. As illustrated in the example of the signaling diagram 200, the AP 102-e may refrain from propagating the timing information 202.

Further, although illustrated in the context of an example in which only the timing information 202 associated with the communication periods of the AP 102-a is propagated throughout a wireless network, any one or more of the AP 102-a, the AP 102-b, the AP 102-c, the AP 102-d, and the AP 102-e may support propagation of multiple different sets of timing information (such as of multiple medium access schedules associated with one or multiple APs 102). In examples in which multiple medium access schedules are propagated throughout the wireless network simultaneously, a propagating AP 102 may include timing information associated with the multiple medium access schedules, and a respective propagation value (such as a hop count value) for each respective schedule of the multiple medium access schedules, in a same set of one or more frames or elements or in different, respective sets of one or more frames or elements. As such, the AP 102-a, the AP 102-b, the AP 102-c, the AP 102-d, and the AP 102-e may support a scheme to convey one or more R-TWT schedules for coordinated multi-AP transmission to reduce latency and increase throughput in multi-hop scenarios.

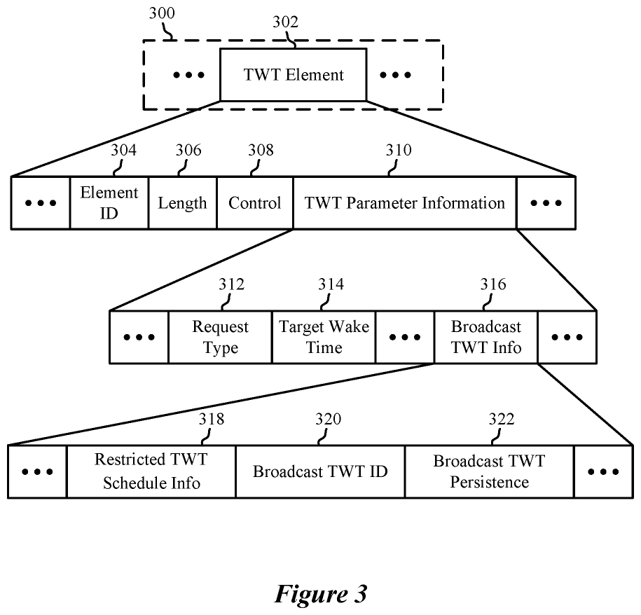

FIG. 3 shows an example frame 300 that supports multi-hop support for coordinated medium access. The frame 300, which may be an example of a management frame or any other type of frame, may be implemented to realize aspects of the wireless communication network 100 or the signaling diagram 200. For example, an AP 102 (such as an AP 102 as illustrated by and described with reference to FIG. 1 or any one of the AP 102-a, the AP 102-b, the AP 102-c, the AP 102-d, and the AP 102-e as illustrated by and described with reference to FIG. 2) may receive or transmit, or both, the frame 300 as part of propagating timing information associated with a medium access schedule (such as communication periods) throughout a wireless network. For example, the frame 300 may be an example of any one of the one or more frames 206-a, the one or more frames 206-b, the one or more frames 206-c, or the one or more frames 206-d as illustrated by and described with reference to FIG. 2.

In some implementations, an AP 102 may extend TWT signaling via a TWT element 302 to carry an indication of a quantity of hops over which timing information associated with a medium access schedule is to be propagated. In some implementations, a new element (such as a TWT Extension element) might carry additional information related to one or more TWT schedules advertised by the AP 102. The extended TWT element or the new element may be carried in a Beacon frame, a Probe Response frame, a (Re)Association Response frame, a broadcast management frame that follows a Beacon frame, or some other management frame which may be sent to a broadcast address or individually addressed to a particular STA 104. The TWT element 302 may include, potentially among other fields, an Element ID field 304, a Length field 306, a Control field 308, a TWT Parameter Information field 310, or any combination thereof. The TWT Parameter Information field 310 may include, potentially among other fields, a Request Type field 312, a Target Wake Time field 314, a Broadcast TWT Info field 316, or any combination thereof. The Broadcast TWT Info field 316 may include, potentially among other fields, a Restricted TWT Schedule Info subfield 318, a Broadcast TWT ID subfield 320, a Broadcast TWT Persistence subfield 322, or any combination thereof. The Broadcast TWT Persistence subfield 322 may be indicative of a quantity of times or a duration during which a corresponding medium access schedule is to be transmitted, and may be expressed in terms of Beacon intervals or a time duration in units of time units (TUs).

In some aspects, an AP 102 may set the Restricted TWT Schedule Info subfield 318 to a value of 3 to indicate that an advertised medium access schedule (such as an R-TWT schedule) is active and is for an AP 102 corresponding to a non-transmitted BSSID that is a member of the same MBSSID set or co-hosted BSSID set as the AP 102 transmitting the Restricted TWT Schedule Info subfield 318. Further, in some aspects, an AP 102 may set the Broadcast TWT ID subfield 320 in an R-TWT parameter set field to a non-zero value, and to 31 if the Restricted TWT Schedule Info subfield 318 is set to 3. As such, an AP 102 may extend one of the values of the Restricted TWT Schedule Info subfield 318 (such as a value of 3) and use values of the Broadcast TWT ID subfield 320 (such as values other than a value of 31 in scenarios in which the Restricted TWT Schedule Info subfield 318 is set to a value of 3) to indicate that some of the parameter set fields carry an indication of a quantity of APs 102 (such as a hop count) and one or more additional related fields that may be expected to be honored and re-announced by friendly APs 102. Such additional fields may include, for example, a group ID field, a BSS color field, an acceptable interference field, or a field indicative of a list of other AP ID, among other examples.

For example, an AP 102 may add some flexibility to the Broadcast TWT ID subfield 320, when the Restricted TWT Schedule Info subfield 318 is set to, for example, a value of 3, to indicate a value associated with a multi-hop propagation of timing information associated with a medium access schedule. In such examples, if an owner announcing AP 102 is one hop away or if the protection is expected to cover a single additional hop, a transmitting AP 102 may set the Restricted TWT Schedule Info subfield 318 to a value of 3 and may set the Broadcast TWT ID subfield 320 to a value of 30 or a value of 1, with the value of 30 or 1 being indicative of a hop count value of 1. Further, if an owner announcing AP 102 is two hops away or if the protection is expected to cover two additional hops, a transmitting AP 102 may set the Restricted TWT Schedule Info subfield 318 to a value of 3 and may set the Broadcast TWT ID subfield 320 to a value of 29 or a value of 2, with the value of 29 or 2 being indicative of a hop count value of 2. Likewise, if an owner announcing AP 102 is three hops away or if the protection is expected to cover three additional hops, a transmitting AP 102 may set the Restricted TWT Schedule Info subfield 318 to a value of 3 and may set the Broadcast TWT ID subfield 320 to a value of 28 or a value of 3, with the value of 28 or 3 being indicative of a hop count value of 3, and so on. As such, the Broadcast TWT ID subfield 320 may be associated with (such as indicative of) the value associated with a multi-hop propagation in accordance with the Restricted TWT Schedule Info subfield 318 being set to a specific value (such as a value of 3). As such, an AP 102 may interpret the Broadcast TWT ID subfield 320 as being indicative of the value in accordance with the Restricted TWT Schedule Info subfield 318 being set to a specific value (such as a value of 3). In some systems, it is also possible that a new value (such as a currently reserved value) is defined for the Broadcast TWT Recommendation field to represent a schedule that belongs to an AP 102 that is more than one hop away.

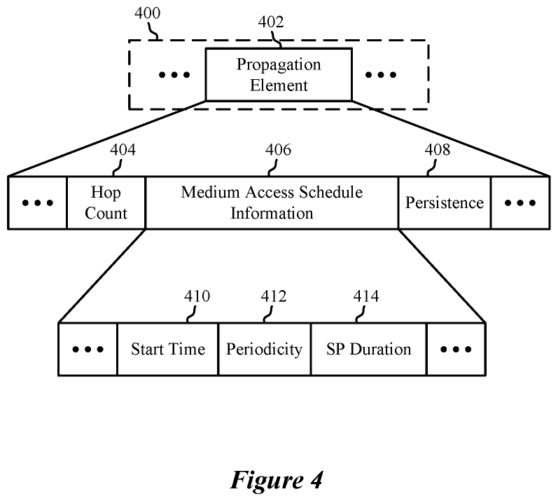

FIG. 4 shows an example frame 400 that supports multi-hop support for coordinated medium access. The frame 400, which may be an example of a management frame or any other type of frame, may be implemented to realize aspects of the wireless communication network 100 or the signaling diagram 200. For example, an AP 102 (such as an AP 102 as illustrated by and described with reference to FIG. 1 or any one of the AP 102-a, the AP 102-b, the AP 102-c, the AP 102-d, and the AP 102-e as illustrated by and described with reference to FIG. 2) may receive or transmit, or both, the frame 400 as part of propagating timing information associated with a medium access schedule (such as communication periods) throughout a wireless network. For example, the frame 400 may be an example of any one of the one or more frames 206-a, the one or more frames 206-b, the one or more frames 206-c, or the one or more frames 206-d as illustrated by and described with reference to FIG. 2.

In some implementations, an AP 102 may use a frame or element dedicated to conveying information associated with multi-hop propagation of medium access schedules to carry an indication of a quantity of hops over which timing information associated with a medium access schedule is to be propagated. Such a frame or element may be understood as being dedicated to conveying information associated with multi-hop propagation of medium access schedules because such a frame or element may be specifically (or exclusively) used for that purpose by function or configuration. For example, the frame 400 may be an example of a frame that is dedicated to conveying information associated with multi-hop propagation of medium access schedules. Additionally, or alternatively, a Propagation element 402 of the frame 400 may be an example of an element that is dedicated to conveying information associated with multi-hop propagation of medium access schedules.

In either example, the Propagation element 402 may carry an indication of a quantity of hops over which timing information associated with a medium access schedule is to be propagated. For example, the Propagation element 402 may include one or more fields including, potentially among other fields, a Hop Count field 404, a Medium Access Schedule Information field 406, a Persistence field 408, or any combination thereof. If included, the Medium Access Schedule Information field 406 may include one or more fields, including, potentially among other fields, a Start Time subfield 410, a Periodicity subfield 412, an SP Duration subfield 414, or any combination thereof. For example, the frame 400 or the Propagation element 402, or both, may be additionally used for other coordinated AP schemes and may carry one or more additional fields that may be used to identify (such as ascertain or otherwise determine) a schedule start time, a periodicity, an SP duration, or a persistence in terms of Beacon intervals or time duration in units of TUs, among other examples. Such a persistence may be used to indicate how many times or for how long a friendly AP 102 may be expected to re-announce propagated timing information. Further, in some implementations, the frame 400 or the Propagation element 402, or both, may include fields or information indicative of a group ID, a BSS color, or one or more transmission parameters (such as transmission parameters that may be used by a propagating AP 102), among other examples of signaling that may assist in coordination between APs 102.

In some implementations, an AP 102 may use the frame 400 or the Propagation element 402 to announce a medium access schedule of a non-friendly AP 102, which other APs 102 may use to avoid experiencing interference from or causing interference to the non-friendly AP 102. Further, in some implementations, an AP 102 may use the frame 400 (which, in some examples, may be transmitted a SIFS after a Beacon frame, such as via a broadcast follow-up frame) or the Propagation element 402 to reduce the amount of information conveyed via a Beacon frame, which may reduce or limit a decoding burden (and associated power consumption) at some client devices that may have parsing constraints (such as legacy STAs 104, as such STAs 104 may be able to refrain from attempting to parse the frame 400 or the Propagation element 402).

FIG. 5 shows an example process flow 500 that supports multi-hop support for coordinated medium access. The process flow 500 may implement or be implemented to realize aspects of the wireless communication network 100, the signaling diagram 200, the frame 300, or the frame 400. For example, a first AP 102 (such as an AP 102 as illustrated by and described with reference to FIG. 1 or any one of the AP 102-a, the AP 102-b, the AP 102-c, the AP 102-d, and the AP 102-e as illustrated by and described with reference to FIG. 2) may operate in accordance with the process flow 500 to select (such as ascertain or otherwise determine) whether to propagate timing information associated with a medium access schedule (such as communication periods) of another AP 102 in accordance with a value associated with a multi-hop propagation of the timing information.

In some examples, the operations illustrated in process flow 500 may be performed by hardware (such as including processor circuitry, memory circuitry, processing blocks, logic components, or other components), a device in association with executing code (such as software or firmware) by a processing system of one or more processors, or any combination thereof. In the following description of the process flow 500, the operations may be performed (such as reported or provided) in a different order than the order shown, or the operations performed by the example devices may be performed in different orders or at different times. Some operations also may be left out of the process flow 500, or other operations may be added to the process flow 500. Further, although some operations or signaling may be shown to occur at different times for discussion purposes, these operations may actually occur at the same time.

At 502, the first AP 102 may power on or otherwise begin operation. In some aspects, beginning operation may be associated with becoming within a transmission range of one or more other (friendly) APs 102.

At 504, the first AP 102 may monitor for one or more neighbor frames. For example, the first AP 102 may monitor for any frames transmitted by one or more neighboring APs 102. In some examples, such frames may be management frames or any other frames that might convey timing information associated with communication periods (such as a medium access schedule) of another AP 102 and a value associated with a multi-hop propagation of the timing information throughout a wireless network.

At 506, for example, the first AP 102 may receive one or more frames in accordance with monitoring and may parse (such as decode or process) the one or more frames for a medium access schedule. In other words, the first AP 102 may parse the one or more frames for timing information associated with communication periods of another (second) AP 102. Such timing information associated with the communication periods may include information indicative of one or more time epochs, one or more SPs, a periodicity, a duration, or any combination thereof, among other examples of timing or scheduling information. In some implementations, the one or more frames may include information indicative of an owner of the medium access schedule (such as an original owner of the R-TWT SP schedule. In some of such implementations (such as in implementations in which the medium access schedule is received directly from the owner), the one or more frames may indicate the owner of the medium access schedule via a Restricted TWT Schedule Info subfield value of 1 or 2 and a non-zero Broadcast TWT ID subfield value. Additionally, or alternatively, the one or more frames may indicate the owner of the medium access schedule via a field that explicitly and uniquely identifies the owner AP 102 (a physically separated AP 102). Such a field that explicitly and uniquely identifies the owner AP 102 may be present in examples in which a specific value of the Restricted TWT Schedule Info subfield (such as a value of 3) is used to trigger a specific interpretation of the Broadcast TWT ID subfield (outside of a value of 31) as being implicitly indicative of a hop count value.

At 508, the first AP 102 may parse the one or more frames for a hop count value associated with the medium access schedule. In other words, the first AP 102 may parse the one or more frames for a value associated with a multi-hop propagation of the timing information associated with the communication periods of the other (second) AP 102. The first AP 102 may receive the value associated with the multi-hop propagation of the timing information associated with the communication periods of the second AP 102 in various ways. In some implementations, the first AP 102 may receive the value via a Broadcast TWT ID subfield, such as the Broadcast TWT ID subfield 320 as illustrated by and described with reference to FIG. 3. For example, a value of the Broadcast TWT ID subfield may be associated with (such as indicative of) the value in examples in which the Restricted TWT Schedule Info subfield value is set to a specific value (such as a value of 3). In some other implementations, the first AP 102 may receive the value via a frame or element that is dedicated to conveying information associated with the multi-hop propagation of the timing information, such as via a Hop Count field 404 of a Propagation element 402 as illustrated by and described with reference to FIG. 4. The value may be an implicit or explicit indication of a hop count associated with the timing information.

In some implementations, the first AP 102 may selectively parse a hop count field (such as the Hop Count field 404) in accordance with a grouping of the first AP 102. For example, the first AP 102 may parse (such as decode or process) a hop count field if the first AP 102 belongs to a same group as the owner AP 102, such that APs 102 that belong to the same group may be expected to parse the hop count field and APs 102 that do not belong to the same group are not expected to parse the hop count field. In some implementations, the first AP 102 may receive an indication of the group associated with the owner AP 102 via the one or more frames. In some examples, a group of APs 102 may be defined such that each AP 102 of the group of APs 102 is associated with a same BSS color, satisfy a same interference level, or have a same traffic type, among other examples.

At 510, the first AP 102 may process the hop count value (as implicitly or explicitly indicated by the value received via the one or more frames) and selectively transmit (such as propagate, re-announcing, or forward), via a frame of the first AP 102, the timing information associated with the communication periods of the second AP 102 in accordance with processing the hop count value. For example, the first AP 102 may either propagate the timing information associated with the communication periods of the second AP 102 or refrain from propagating the timing information associated with the communication periods of the second AP 102 in accordance with how the hop count value compares to one or more threshold values.

At 512, for example, the first AP 102 may determine that the hop count value is equal to a first value. In such examples, the first AP 102 may refrain from honoring and refrain from re-announcing the timing information associated with the communication periods of the second AP 102 (which may be understood as the medium access schedule of the second AP 102) in accordance with the hop count value being equal to the first value. For example, if the hop count value is equal to 0, the first AP 102 may not honor (or at least may not be expected to honor) and may not re-announce the schedule in frames transmitted by the first AP 102 (such as in management frames of the first AP 102). As such, a hop count value being equal to the first value may, in addition to indicating that the first AP 102 is not expected to re-announce the corresponding medium access schedule, indicate a coordination status between the first AP 102 and the second (medium access schedule owner) AP 102, the coordination status being associated with no expectation for the first AP 102 to honor the medium access schedule of the second AP 102.

At 514, for further example, the first AP 102 may determine that the hop count value is equal to a second value. In such examples, the first AP 102 may honor the communication periods of the second AP 102 but refrain from re-announcing the timing information associated with the communication periods of the second AP 102 in accordance with the hop count value being equal to the second value. For example, the if hop count value is equal to 1, the first AP 102 may honor the schedule but may not re-announce the schedule in frames transmitted by the first AP 102 (such as in management frames of the first AP 102). As such, a hop count value being equal to the second value may, in addition to indicating that the first AP 102 is not expected to re-announce the corresponding medium access schedule, indicate a coordination status between the first AP 102 and the second (medium access schedule owner) AP 102, the coordination status being associated with an expectation for the first AP 102 to honor the medium access schedule of the second AP 102.

Alternatively, if the first AP 102 determines that the hop count value is greater than the second value, the first AP 102 may honor the schedule, update the hop count value, and re-announce the schedule in frames transmitted by the first AP 102 (such as in management frames of the first AP 102) such that client devices of the first AP 102 may honor the schedule. As such, a hop count value being greater than the second value may, in addition to indicating that the first AP 102 is expected to re-announce the corresponding medium access schedule, indicate a coordination status between the first AP 102 and the second (medium access schedule owner) AP 102, the coordination status being associated with an expectation for the first AP 102 to honor the medium access schedule of the second AP 102. As part of re-announcing the medium access schedule, the first AP 102 may indicate that the re-announced schedule is for another AP 102 (such as via a Restricted TWT Schedule Info subfield and a Broadcast TWT ID subfield) and may further transmit, along with the announced schedule (in a same frame or in different frames), an indication of the updated hop count value. In some implementations, the first AP 102 may, in addition to determining that the hop count value is greater than the second value, determine whether to honor and re-announce the schedule of the second AP 102 in accordance with one or more criteria.

For example, at 516, the first AP 102 may determine (such as identify, select, or ascertain) whether one or more criteria are satisfied. Such criteria may include one or more communication parameters provided by the second AP 102 (such as via the one or more frames) or one or more communication parameters selected by the first AP 102 that receives the one or more frames, or any combination thereof. An example of a communication parameter provided by the second AP 102 may include an acceptable interference level. An example of a communication parameter selected by the first AP 102 that receives the one or more frames may include a transmission power.

At 518, and (if applicable) in examples in which the one or more criteria are satisfied, the first AP 102 may update the hop count value associated with the multi-hop propagation of the medium access schedule of the second AP 102. Such an updating of the hop count value may include incrementing the hop count value (such as by 1) or decrementing the hop count value (such as by 1). In other words, the hop count value may count down (such as toward a final value of 0) or may count up (such as from an initial value of 0). In examples in which the hop count value counts down, a value of 0 may indicate that a receiving AP 102 is not expected to honor or propagate the schedule any further, with values above 0 indicating that a receiving AP 102 is expected to honor the schedule or re-announce the schedule, or both. Alternatively, in examples in which the hop count value counts up, an upper limit value may indicate that a receiving AP 102 is not expected to honor or propagate the schedule any further, with values below the upper limit value indicating that a receiving AP 102 is expected to honor the schedule or re-announce the schedule, or both. In such examples in which the hop count value counts up, an owner AP 102 and each AP 102 that propagates the schedule of the owner AP 102 may include an indication of the upper limit value in the one or more frames.

At 520, the first AP 102 may honor and re-announce (such as transmit or broadcast) the timing information associated with the communication periods of the second AP 102 (which may be understood as the medium access schedule of the second AP 102). The first AP 102 may additionally announce, via a same frame carrying the timing information or a different frame, an updated value associated with the multi-hop propagation of the timing information. The updated value may be implicitly or explicitly indicative of the incremented or decremented hop count value.

Alternatively, at 522, if the one or more criteria associated with propagation of the timing information are not satisfied, the first AP 102 may refrain from honoring or refrain from re-announcing the timing information associated with the communication periods of the second AP 102 (which may be understood as the medium access schedule of the second AP 102), or both.

In addition to, or as an alternative to, monitoring for one or more frames and selectively propagating timing information of medium access schedules of other APs 102 in accordance with a value associated with a multi-hop propagation of the timing information, the first AP 102 may support one or more signaling mechanisms to explicitly solicit the latest (such as the most up to date or most recent) coordinated medium access schedules from one or more other APs 102. Such an explicit solicitation of (such as a request for) the latest medium access schedules may support greater reliability and greater efficiency, as an AP 102 that misses timing information transmitted by another AP 102 (such as due to a communication conflict) may still obtain that timing information via the explicit solicitation.

At 524, for example, the first AP 102 may transmit a request, to at least one other AP 102, for a set of one or more most recent medium access schedules. The first AP 102 may transmit the request via unicast signaling (such as to obtain medium access schedules known by (such as stored by) a specific AP 102) or broadcast signaling (such as to obtain medium access schedules known by (such as stored by) potentially multiple nearby APs 102).

At 526, the first AP 102 may receive the set of one or more most recent medium access schedules in association with (such as responsive to) transmitting the request. In some examples, the set of one or more most recent medium access schedules may include both a first set of one or more most recent medium access schedules associated with (such as owned by) a replying AP 102 and a second set of one or more most recent medium access schedules propagated by the replying AP 102 (such as in accordance with a multi-hop propagation of coordinated medium access schedules). The first AP may receive the set of one or more most recent medium access schedules via unicast signaling or via broadcast signaling. In some aspects, such a solicitation for and reception of a set of one or more most recent medium access schedules may be in association with information sharing and to provide friendly APs 102 information indicative of a status of active coordinated medium access schedules (as opposed to, for example, a negotiation of coordinated medium access schedules).

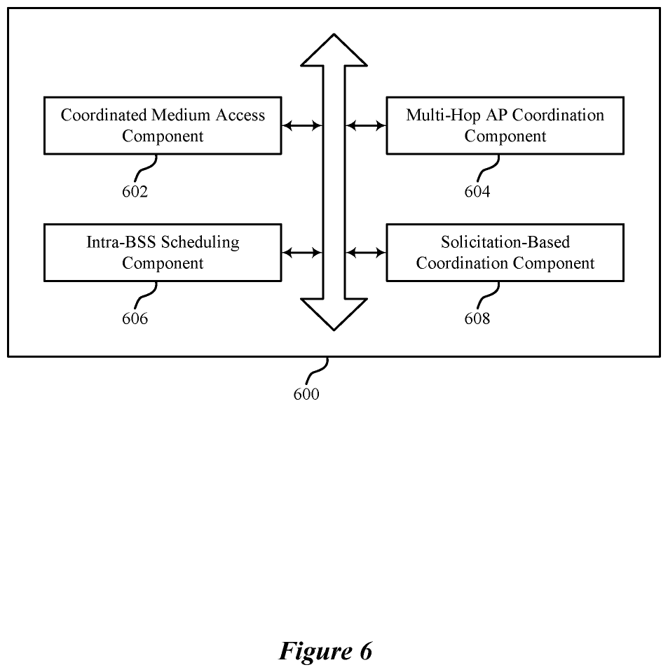

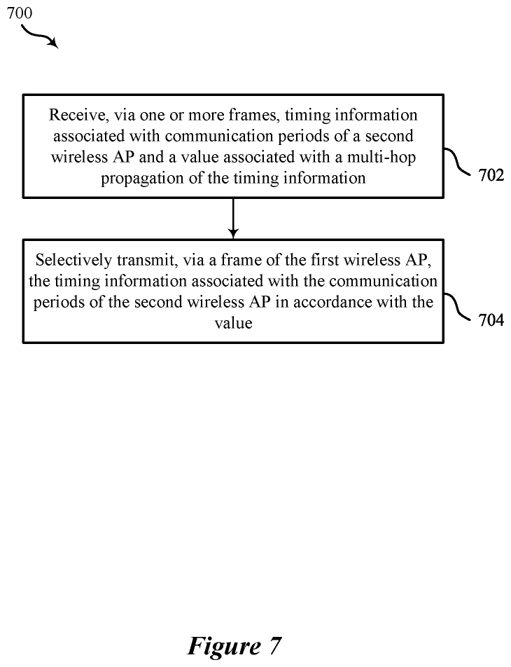

FIG. 6 shows a block diagram of an example wireless communication device 600 that supports multi-hop support for coordinated medium access. In some examples, the wireless communication device 600 is configured to perform the processes 700, 800, 900, and 1000 described with reference to FIGS. 7, 8, 9, and 10, respectively. The wireless communication device 600 may include one or more chips, SoCs, chipsets, packages, components or devices that individually or collectively constitute or include a processing system. The processing system may interface with other components of the wireless communication device 600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 600 may transmit the information output from the chip. In such an example, the second interface may refer to an interface between the processing system of the chip and a reception component, such that the wireless communication device 600 may receive information that is then passed to the processing system. In some such examples, the first interface also may obtain information, such as from the transmission component, and the second interface also may output information, such as to the reception component.

The processing system of the wireless communication device 600 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 600 can configurable or configured for use in an AP, such as the AP 102 described with reference to FIG. 1. In some other examples, the wireless communication device 600 can be an AP that includes such a processing system and other components including multiple antennas. The wireless communication device 600 is capable of transmitting and receiving wireless communications in the form of, for example, wireless packets. For example, the wireless communication device 600 can be configurable or configured to transmit and receive packets in the form of physical layer PPDUs and MPDUs conforming to one or more of the IEEE 802.11 family of wireless communication protocol standards. In some other examples, the wireless communication device 600 can be configurable or configured to transmit and receive signals and communications conforming to one or more 3GPP specifications including those for 5G NR or 6G. In some examples, the wireless communication device 600 also includes or can be coupled with one or more application processors which may be further coupled with one or more other memories. In some examples, the wireless communication device 600 further includes at least one external network interface coupled with the processing system that enables communication with a core network or backhaul network that enables the wireless communication device 600 to gain access to external networks including the Internet.

The wireless communication device 600 includes a coordinated medium access component 602, a multi-hop AP coordination component 604, an intra-BSS scheduling component 606, and a solicitation-based coordination component 608. Portions of one or more of the coordinated medium access component 602, the multi-hop AP coordination component 604, the intra-BSS scheduling component 606, and the solicitation-based coordination component 608 may be implemented at least in part in hardware or firmware. For example, one or more of the coordinated medium access component 602, the multi-hop AP coordination component 604, the intra-BSS scheduling component 606, and the solicitation-based coordination component 608 may be implemented at least in part by at least a processor or a modem. In some examples, portions of one or more of the coordinated medium access component 602, the multi-hop AP coordination component 604, the intra-BSS scheduling component 606, and the solicitation-based coordination component 608 may be implemented at least in part by a processor and software in the form of processor-executable code stored in memory.

The wireless communication device 600 may support wireless communication in accordance with examples as disclosed herein. The coordinated medium access component 602 is configurable or configured to receive, via one or more frames, timing information associated with communication periods of a second wireless AP and a value associated with a multi-hop propagation of the timing information. The multi-hop AP coordination component 604 is configurable or configured to selectively transmit, via a frame of the first wireless AP, the timing information associated with the communication periods of the second wireless AP in accordance with the value.

In some examples, to support receiving the value associated with the multi-hop propagation of the timing information, the multi-hop AP coordination component 604 is configurable or configured to receive the value via a broadcast target wake time (TWT) identifier (ID) field.

In some examples, the broadcast TWT ID field is associated with the value in accordance with a TWT schedule information subfield being set to a second value.

In some examples, the value be indicative of a presence, within a TWT element associated with the broadcast TWT ID field, of one or more additional fields associated with the multi-hop propagation of the timing information.

In some examples, the one or more additional fields include a group ID field, a basic service set (BSS) color field, an acceptable interference field, a field indicative of a list of other AP IDs, or any combination thereof, the one or more additional fields to be propagated with the timing information.

In some examples, to support receiving the value associated with the multi-hop propagation of the timing information, the multi-hop AP coordination component 604 is configurable or configured to receive the value via a hop count field of a frame or element dedicated to conveying information associated with the multi-hop propagation of the timing information.

In some examples, the multi-hop AP coordination component 604 is configurable or configured to receive, via the frame or element, one or more additional fields associated with the multi-hop propagation of the timing information.

In some examples, the one or more additional fields include a schedule start time field, a periodicity field, a service period duration field, a persistence field, a group ID field, a basic service set (BSS) color field, a transmission parameter field, or any combination thereof, the one or more additional fields to be propagated with the timing information.

In some examples, to support selectively transmitting the timing information, the multi-hop AP coordination component 604 is configurable or configured to transmit the timing information in association with the value indicating that the first wireless AP is to propagate the timing information.

In some examples, the multi-hop AP coordination component 604 is configurable or configured to transmit an updated value in association with transmitting the timing information via the frame of the first wireless AP, where the updated value is associated with an increment or a decrement of the value.

In some examples, the update value is transmitted via the frame or a second frame of the first wireless AP.

In some examples, to support selectively transmitting the timing information, the multi-hop AP coordination component 604 is configurable or configured to refrain from transmitting the timing information in association with the value indicating that the first wireless AP is to refrain from propagating the timing information.

In some examples, the intra-BSS scheduling component 606 is configurable or configured to transmit scheduling information to one or more wireless stations (STAs) associated with the first wireless AP in accordance with the value, where the value is further associated with a coordination status between the first wireless AP and the second wireless AP.

In some examples, the intra-BSS scheduling component 606 is configurable or configured to communicate with the one or more wireless STAs outside of the communication periods of the second wireless AP in accordance with the value indicating a first coordination status, the first coordination status being associated with an expectation to honor the communication periods of the second wireless AP. In some examples, the intra-BSS scheduling component 606 is configurable or configured to communicate with the one or more wireless STAs during at least a portion of the communication periods of the second wireless AP in accordance with the value indicating a second coordination status, the second coordination status being associated with no expectation to honor the communication periods of the second wireless AP.

In some examples, the coordinated medium access component 602 is configurable or configured to receive, via one or more second frames, the timing information associated with the communication periods of the second wireless AP and a second value associated with the multi-hop propagation of the timing information. In some examples, the multi-hop AP coordination component 604 is configurable or configured to select the value instead of the second value in accordance with one or more criteria.

In some examples, to support selecting the value instead of the second value, the multi-hop AP coordination component 604 is configurable or configured to select the value in accordance with the value being relatively lower than the second value. In some examples, to support selecting the value instead of the second value, the multi-hop AP coordination component 604 is configurable or configured to select the value in accordance with the value being relatively higher than the second value. In some examples, to support selecting the value instead of the second value, the multi-hop AP coordination component 604 is configurable or configured to select the value in accordance with the one or more frames being of the second wireless AP.

In some examples, the coordinated medium access component 602 is configurable or configured to receive, via the one or more frames, information indicative of a group to which the second wireless AP belongs. In some examples, the multi-hop AP coordination component 604 is configurable or configured to propagate the timing information associated with the communication periods of the second wireless AP and honor the communication periods of the second wireless AP in accordance with the first wireless AP and the second wireless AP belonging to a same group.

In some examples, the multi-hop AP coordination component 604 is configurable or configured to propagate the timing information associated with the communication periods of the second wireless AP and honor the communication periods of the second wireless AP in accordance with one or more communication parameters satisfying one or more criteria.

In some examples, the one or more communication parameters be received via the one or more frames or are selected by the first wireless AP, or any combination thereof.

In some examples, the solicitation-based coordination component 608 is configurable or configured to transmit, to a third wireless AP, a first frame including a request for information indicative of a set of most recent medium access schedules. In some examples, the solicitation-based coordination component 608 is configurable or configured to receive, from the third wireless AP, a second frame including the information indicative of the set of most recent medium access schedules, the set of most recent medium access schedules including one or more first medium access schedules of the third wireless AP and one or more second medium access schedules of one or more other wireless APs propagated by the third wireless AP.

In some examples, the value be a hop count associated with the multi-hop propagation of the timing information.

In some examples, the first wireless AP and the second wireless AP be physically separated wireless APs.

Additionally, or alternatively, the wireless communication device 600 may support wireless communication in accordance with examples as disclosed herein. In some examples, the multi-hop AP coordination component 604 is configurable or configured to generate one or more frames to include timing information associated with communication periods of the first wireless AP and a value associated with a multi-hop propagation of the timing information. In some examples, the coordinated medium access component 602 is configurable or configured to transmit, via the one or more frames, the timing information and the value associated with the multi-hop propagation of the timing information.

In some examples, to support transmitting the value associated with the multi-hop propagation of the timing information, the multi-hop AP coordination component 604 is configurable or configured to transmit the value via a broadcast target wake time (TWT) identifier (ID) field.

In some examples, the broadcast TWT ID field is associated with the value in accordance with a TWT schedule information subfield being set to a second value.

In some examples, the value be indicative of a presence, within a TWT element associated with the broadcast TWT ID field, of one or more additional fields associated with the multi-hop propagation of the timing information.

In some examples, the one or more additional fields include a group ID field, a basic service set (BSS) color field, an acceptable interference field, a field indicative of a list of other AP IDs, or any combination thereof, the one or more additional fields to be propagated with the timing information.

In some examples, to support transmitting the value associated with the multi-hop propagation of the timing information, the multi-hop AP coordination component 604 is configurable or configured to transmit the value via a hop count field of a frame or element dedicated to conveying information associated with the multi-hop propagation of the timing information.

In some examples, the multi-hop AP coordination component 604 is configurable or configured to transmit, via the frame or element, one or more additional fields associated with the multi-hop propagation of the timing information.

In some examples, the one or more additional fields include a schedule start time field, a periodicity field, a service period duration field, a persistence field, a group ID field, a basic service set (BSS) color field, a transmission parameter field, or any combination thereof.

In some examples, the multi-hop AP coordination component 604 is configurable or configured to transmit, via the one or more frames, information indicative of a group to which the first wireless AP belongs, where one or more other wireless APs are expected to propagate the timing information associated with the communication periods of the first wireless AP and honor the communication periods of the first wireless AP in accordance with the first wireless AP and the one or more other wireless APs belonging to a same group.

In some examples, the multi-hop AP coordination component 604 is configurable or configured to transmit, via the one or more frames, information indicative of one or more communication parameters, where one or more other wireless APs are expected to propagate the timing information associated with the communication periods of the first wireless AP and honor the communication periods of the first wireless AP in accordance with the one or more communication parameters satisfying one or more criteria at the one or more other wireless APs.

In some examples, the solicitation-based coordination component 608 is configurable or configured to receive, from a second wireless AP, a first frame including a request for information indicative of a set of most recent medium access schedules. In some examples, the solicitation-based coordination component 608 is configurable or configured to transmit, to at least the second wireless AP, a second frame including the information indicative of the set of most recent medium access schedules, the set of most recent medium access schedules including one or more first medium access schedules of the first wireless AP and one or more second medium access schedules of one or more other wireless APs propagated by the first wireless AP.

In some examples, the value be a hop count associated with the multi-hop propagation of the timing information.

FIG. 7 shows a flowchart illustrating an example process 700 performable by or at a first wireless AP that supports multi-hop support for coordinated medium access. The operations of the process 700 may be implemented by a first wireless AP or its components as described herein. For example, the process 700 may be performed by a wireless communication device, such as the wireless communication device 600 described with reference to FIG. 6, operating as or within a wireless AP. In some examples, the process 700 may be performed by a wireless AP, such as one of the APs 102 described with reference to FIG. 1.

In some examples, in block 702, the first wireless AP may receive, via one or more frames, timing information associated with communication periods of a second wireless AP and a value associated with a multi-hop propagation of the timing information. The operations of block 702 may be performed in accordance with examples as disclosed herein. In some implementations, aspects of the operations of block 702 may be performed by a coordinated medium access component 602 as described with reference to FIG. 6.

In some examples, in block 704, the first wireless AP may selectively transmit, via a frame of the first wireless AP, the timing information associated with the communication periods of the second wireless AP in accordance with the value. The operations of block 704 may be performed in accordance with examples as disclosed herein. In some implementations, aspects of the operations of block 704 may be performed by a multi-hop AP coordination component 604 as described with reference to FIG. 6.

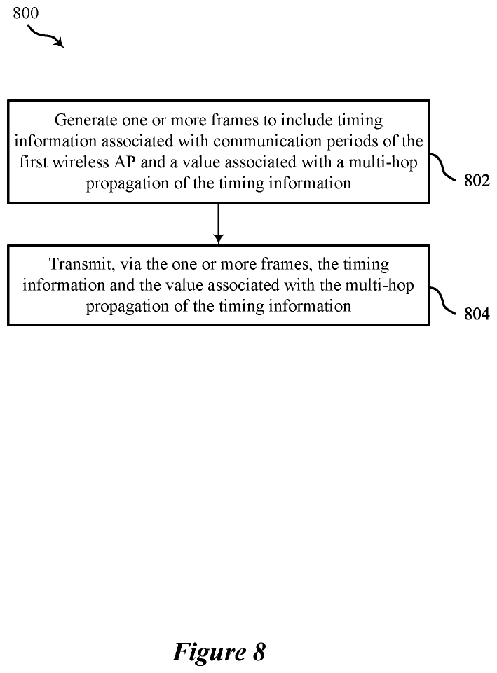

FIG. 8 shows a flowchart illustrating an example process 800 performable by or at a first wireless AP that supports multi-hop support for coordinated medium access. The operations of the process 800 may be implemented by a first wireless AP or its components as described herein. For example, the process 800 may be performed by a wireless communication device, such as the wireless communication device 600 described with reference to FIG. 6, operating as or within a wireless AP. In some examples, the process 800 may be performed by a wireless AP, such as one of the APs 102 described with reference to FIG. 1.

In some examples, in block 802, the first wireless AP may generate one or more frames to include timing information associated with communication periods of the first wireless AP and a value associated with a multi-hop propagation of the timing information. The operations of block 802 may be performed in accordance with examples as disclosed herein. In some implementations, aspects of the operations of block 802 may be performed by a multi-hop AP coordination component 604 as described with reference to FIG. 6.

In some examples, in block 804, the first wireless AP may transmit, via the one or more frames, the timing information and the value associated with the multi-hop propagation of the timing information. The operations of block 804 may be performed in accordance with examples as disclosed herein. In some implementations, aspects of the operations of block 804 may be performed by a coordinated medium access component 602 as described with reference to FIG. 6.

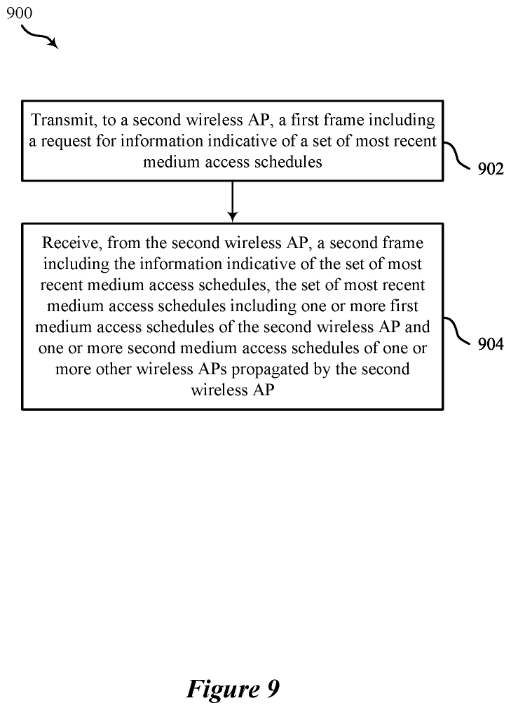

FIG. 9 shows a flowchart illustrating an example process 900 performable by or at a first wireless AP that supports multi-hop support for coordinated medium access. The operations of the process 900 may be implemented by a first wireless AP or its components as described herein. For example, the process 900 may be performed by a wireless communication device, such as the wireless communication device 600 described with reference to FIG. 6, operating as or within a wireless AP. In some examples, the process 900 may be performed by a wireless AP, such as one of the APs 102 described with reference to FIG. 1.

In some examples, in block 902, the first wireless AP may transmit, to a second wireless AP, a first frame including a request for information indicative of a set of most recent medium access schedules. The operations of block 902 may be performed in accordance with examples as disclosed herein. In some implementations, aspects of the operations of block 902 may be performed by a solicitation-based coordination component 608 as described with reference to FIG. 6.

In some examples, in block 904, the first wireless AP may receive, from the second wireless AP, a second frame including the information indicative of the set of most recent medium access schedules, the set of most recent medium access schedules including one or more first medium access schedules of the second wireless AP and one or more second medium access schedules of one or more other wireless APs propagated by the second wireless AP. The operations of block 904 may be performed in accordance with examples as disclosed herein. In some implementations, aspects of the operations of block 904 may be performed by a solicitation-based coordination component 608 as described with reference to FIG. 6.

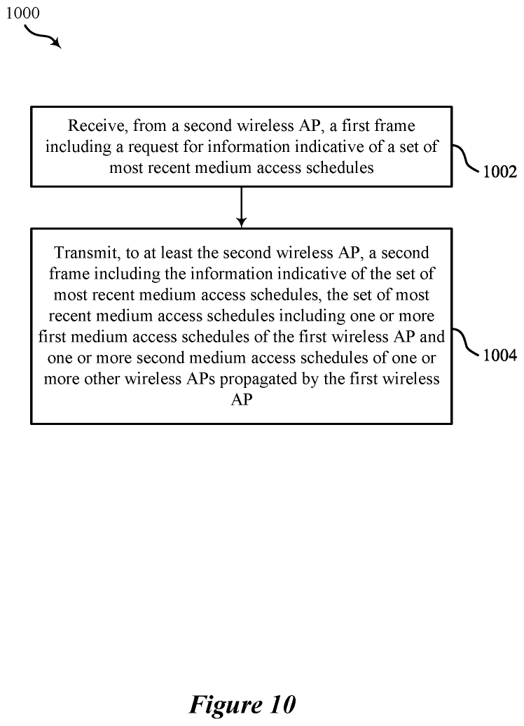

FIG. 10 shows a flowchart illustrating an example process 1000 performable by or at a first wireless AP that supports multi-hop support for coordinated medium access. The operations of the process 1000 may be implemented by a first wireless AP or its components as described herein. For example, the process 1000 may be performed by a wireless communication device, such as the wireless communication device 600 described with reference to FIG. 6, operating as or within a wireless AP. In some examples, the process 1000 may be performed by a wireless AP, such as one of the APs 102 described with reference to FIG. 1.

In some examples, in block 1002, the first wireless AP may receive, from a second wireless AP, a first frame including a request for information indicative of a set of most recent medium access schedules. The operations of block 1002 may be performed in accordance with examples as disclosed herein. In some implementations, aspects of the operations of block 1002 may be performed by a solicitation-based coordination component 608 as described with reference to FIG. 6.

In some examples, in block 1004, the first wireless AP may transmit, to at least the second wireless AP, a second frame including the information indicative of the set of most recent medium access schedules, the set of most recent medium access schedules including one or more first medium access schedules of the first wireless AP and one or more second medium access schedules of one or more other wireless APs propagated by the first wireless AP. The operations of block 1004 may be performed in accordance with examples as disclosed herein. In some implementations, aspects of the operations of block 1004 may be performed by a solicitation-based coordination component 608 as described with reference to FIG. 6.

Implementation examples are described in the following numbered clauses:

Clause 1: A method for wireless communication by a first wireless AP, including: receiving, via one or more frames, timing information associated with communication periods of a second wireless AP and a value associated with a multi-hop propagation of the timing information; and selectively transmitting, via a frame of the first wireless AP, the timing information associated with the communication periods of the second wireless AP in accordance with the value.

Clause 2: The method of clause 1, where receiving the value associated with the multi-hop propagation of the timing information further includes: receiving the value via a broadcast target wake time (TWT) identifier (ID) field.

Clause 3: The method of clause 2, where the broadcast TWT ID field is associated with the value in accordance with a TWT schedule information subfield being set to a second value.

Clause 4: The method of any of clauses 2 through 3, where the value is indicative of a presence, within a TWT element associated with the broadcast TWT ID field, of one or more additional fields associated with the multi-hop propagation of the timing information.

Clause 5: The method of clause 4, where the one or more additional fields include a group ID field, a basic service set (BSS) color field, an acceptable interference field, a field indicative of a list of other AP IDs, or any combination thereof, the one or more additional fields to be propagated with the timing information.

Clause 6: The method of any of clauses 1 through 5, where receiving the value associated with the multi-hop propagation of the timing information further includes: receiving the value via a hop count field of a frame or element dedicated to conveying information associated with the multi-hop propagation of the timing information.

Clause 7: The method of clause 6, further including: receiving, via the frame or element, one or more additional fields associated with the multi-hop propagation of the timing information.

Clause 8: The method of clause 7, where the one or more additional fields include a schedule start time field, a periodicity field, a service period duration field, a persistence field, a group ID field, a basic service set (BSS) color field, a transmission parameter field, or any combination thereof, the one or more additional fields to be propagated with the timing information.

Clause 9: The method of any of clauses 1 through 8, where selectively transmitting the timing information further includes: transmitting the timing information in association with the value indicating that the first wireless AP is to propagate the timing information.

Clause 10: The method of clause 9, further including: transmitting an updated value in association with transmitting the timing information via the frame of the first wireless AP, where the updated value is associated with an increment or a decrement of the value.

Clause 11: The method of clause 10, where the updated value is transmitted via the frame or a second frame of the first wireless AP.

Clause 12: The method of any of clauses 1 through 11, where selectively transmitting the timing information further includes: refraining from transmitting the timing information in association with the value indicating that the first wireless AP is to refrain from propagating the timing information.

Clause 13: The method of any of clauses 1 through 12, further including: transmitting scheduling information to one or more wireless stations (STAs) associated with the first wireless AP in accordance with the value, where the value is further associated with a coordination status between the first wireless AP and the second wireless AP.

Clause 14: The method of clause 13, further including: communicating with the one or more wireless STAs outside of the communication periods of the second wireless AP in accordance with the value indicating a first coordination status, the first coordination status being associated with an expectation to honor the communication periods of the second wireless AP; or communicating with the one or more wireless STAs during at least a portion of the communication periods of the second wireless AP in accordance with the value indicating a second coordination status, the second coordination status being associated with no expectation to honor the communication periods of the second wireless AP.

Clause 15: The method of any of clauses 1 through 14, further including: receiving, via one or more second frames, the timing information associated with the communication periods of the second wireless AP and a second value associated with the multi-hop propagation of the timing information; and selecting the value instead of the second value in accordance with one or more criteria.

Clause 16: The method of clause 15, where selecting the value instead of the second value further includes: selecting the value in accordance with the value being relatively lower than the second value; selecting the value in accordance with the value being relatively higher than the second value; or selecting the value in accordance with the one or more frames being of the second wireless AP.

Clause 17: The method of any of clauses 1 through 16, further including: receiving, via the one or more frames, information indicative of a group to which the second wireless AP belongs; and propagating the timing information associated with the communication periods of the second wireless AP and honoring the communication periods of the second wireless AP in accordance with the first wireless AP and the second wireless AP belonging to a same group.

Clause 18: The method of any of clauses 1 through 17, further including: propagating the timing information associated with the communication periods of the second wireless AP and honoring the communication periods of the second wireless AP and in accordance with one or more communication parameters satisfying one or more criteria.

Clause 19: The method of clause 18, where the one or more communication parameters are received via the one or more frames or are selected by the first wireless AP, or any combination thereof.

Clause 20: The method of any of clauses 1 through 19, further including: transmitting, to a third wireless AP, a first frame including a request for information indicative of a set of most recent medium access schedules; and receiving, from the third wireless AP, a second frame including the information indicative of the set of most recent medium access schedules, the set of most recent medium access schedules including one or more first medium access schedules of the third wireless AP and one or more second medium access schedules of one or more other wireless APs propagated by the third wireless AP.

Clause 21: The method of any of clauses 1 through 20, where the value is a hop count associated with the multi-hop propagation of the timing information.

Clause 22: The method of any of clauses 1 through 21, where the first wireless AP and the second wireless AP are physically separated wireless APs.

Clause 23: A method for wireless communication by a first wireless AP, including: generating one or more frames to include timing information associated with communication periods of the first wireless AP and a value associated with a multi-hop propagation of the timing information; and transmitting, via the one or more frames, the timing information and the value associated with the multi-hop propagation of the timing information.

Clause 24: The method of clause 23, where transmitting the value associated with the multi-hop propagation of the timing information further includes: transmitting the value via a broadcast target wake time (TWT) identifier (ID) field.

Clause 25: The method of clause 24, where the broadcast TWT ID field is associated with the value in accordance with a TWT schedule information subfield being set to a second value.

Clause 26: The method of any of clauses 24 through 25, where the value is indicative of a presence, within a TWT element associated with the broadcast TWT ID field, of one or more additional fields associated with the multi-hop propagation of the timing information.

Clause 27: The method of clause 26, where the one or more additional fields include a group ID field, a basic service set (BSS) color field, an acceptable interference field, a field indicative of a list of other AP IDs, or any combination thereof, the one or more additional fields to be propagated with the timing information.

Clause 28: The method of any of clauses 23 through 27, where transmitting the value associated with the multi-hop propagation of the timing information further includes: transmitting the value via a hop count field of a frame or element dedicated to conveying information associated with the multi-hop propagation of the timing information.

Clause 29: The method of clause 28, further including: transmitting, via the frame or element, one or more additional fields associated with the multi-hop propagation of the timing information.

Clause 30: The method of clause 29, where the one or more additional fields include a schedule start time field, a periodicity field, a service period duration field, a persistence field, a group ID field, a basic service set (BSS) color field, a transmission parameter field, or any combination thereof.

Clause 31: The method of any of clauses 23 through 30, further including: transmitting, via the one or more frames, information indicative of a group to which the first wireless AP belongs, where one or more other wireless APs are expected to propagate the timing information associated with the communication periods of the first wireless AP and honor the communication periods of the first wireless AP in accordance with the first wireless AP and the one or more other wireless APs belonging to a same group.

Clause 32: The method of any of clauses 23 through 31, further including: transmitting, via the one or more frames, information indicative of one or more communication parameters, where one or more other wireless APs are expected to propagate the timing information associated with the communication periods of the first wireless AP and honor the communication periods of the first wireless AP in accordance with the one or more communication parameters satisfying one or more criteria at the one or more other wireless APs.

Clause 33: The method of any of clauses 23 through 32, further including: receiving, from a second wireless AP, a first frame including a request for information indicative of a set of most recent medium access schedules; and transmitting, to at least the second wireless AP, a second frame including the information indicative of the set of most recent medium access schedules, the set of most recent medium access schedules including one or more first medium access schedules of the first wireless AP and one or more second medium access schedules of one or more other wireless APs propagated by the first wireless AP.

Clause 34: The method of any of clauses 23 through 33, where the value is a hop count associated with the multi-hop propagation of the timing information.

Clause 35: A first wireless AP, including: a processing system that includes processor circuitry and memory circuitry that stores code, the processing system configured to cause the first wireless AP to: receive, via one or more frames, timing information associated with communication periods of a second wireless AP and a value associated with a multi-hop propagation of the timing information; and selectively transmit, via a frame of the first wireless AP, the timing information associated with the communication periods of the second wireless AP in accordance with the value.

Clause 36: The first wireless AP of clause 35, where, to receive the value associated with the multi-hop propagation of the timing information, the processing system is further configured to cause the first wireless AP to: receive the value via a broadcast target wake time (TWT) identifier (ID) field.

Clause 37: The first wireless AP of clause 36, where the broadcast TWT ID field is associated with the value in accordance with a TWT schedule information subfield being set to a second value.

Clause 38: The first wireless AP of any of clauses 36 through 37, where the value is indicative of a presence, within a TWT element associated with the broadcast TWT ID field, of one or more additional fields associated with the multi-hop propagation of the timing information.

Clause 39: The first wireless AP of clause 38, where the one or more additional fields include a group ID field, a basic service set (BSS) color field, an acceptable interference field, a field indicative of a list of other AP IDs, or any combination thereof, the one or more additional fields to be propagated with the timing information.

Clause 40: The first wireless AP of any of clauses 35 through 39, where, to receive the value associated with the multi-hop propagation of the timing information, the processing system is further configured to cause the first wireless AP to: receive the value via a hop count field of a frame or element dedicated to conveying information associated with the multi-hop propagation of the timing information.

Clause 41: The first wireless AP of clause 40, where the processing system is further configured to cause the first wireless AP to: receive, via the frame or element, one or more additional fields associated with the multi-hop propagation of the timing information.

Clause 42: The first wireless AP of clause 41, where the one or more additional fields include a schedule start time field, a periodicity field, a service period duration field, a persistence field, a group ID field, a basic service set (BSS) color field, a transmission parameter field, or any combination thereof, the one or more additional fields to be propagated with the timing information.

Clause 43: The first wireless AP of any of clauses 35 through 42, where, to selectively transmit the timing information, the processing system is further configured to cause the first wireless AP to: transmit the timing information in association with the value indicating that the first wireless AP is to propagate the timing information.

Clause 44: The first wireless AP of clause 43, where the processing system is further configured to cause the first wireless AP to: transmit an updated value in association with transmitting the timing information via the frame of the first wireless AP, where the updated value is associated with an increment or a decrement of the value.

Clause 45: The first wireless AP of clause 44, where the updated value is transmitted via the frame or a second frame of the first wireless AP.

Clause 46: The first wireless AP of any of clauses 35 through 45, where, to selectively transmit the timing information, the processing system is further configured to cause the first wireless AP to: refrain from transmitting the timing information in association with the value indicating that the first wireless AP is to refrain from propagating the timing information.

Clause 47: The first wireless AP of any of clauses 35 through 46, where the processing system is further configured to cause the first wireless AP to: transmit scheduling information to one or more wireless stations (STAs) associated with the first wireless AP in accordance with the value, where the value is further associated with a coordination status between the first wireless AP and the second wireless AP.

Clause 48: The first wireless AP of clause 47, where the processing system is further configured to cause the first wireless AP to: communicate with the one or more wireless STAs outside of the communication periods of the second wireless AP in accordance with the value indicating a first coordination status, the first coordination status being associated with an expectation to honor the communication periods of the second wireless AP; or communicate with the one or more wireless STAs during at least a portion of the communication periods of the second wireless AP in accordance with the value indicating a second coordination status, the second coordination status being associated with no expectation to honor the communication periods of the second wireless AP.

Clause 49: The first wireless AP of any of clauses 35 through 48, where the processing system is further configured to cause the first wireless AP to: receive, via one or more second frames, the timing information associated with the communication periods of the second wireless AP and a second value associated with the multi-hop propagation of the timing information; and select the value instead of the second value in accordance with one or more criteria.

Clause 50: The first wireless AP of clause 49, where, to select the value instead of the second value, the processing system is further configured to cause the first wireless AP to: select the value in accordance with the value being relatively lower than the second value; select the value in accordance with the value being relatively higher than the second value; or select the value in accordance with the one or more frames being of the second wireless AP.

Clause 51: The first wireless AP of any of clauses 35 through 50, where the processing system is further configured to cause the first wireless AP to: receive, via the one or more frames, information indicative of a group to which the second wireless AP belongs; and propagate the timing information associated with the communication periods of the second wireless AP and honor the communication periods of the second wireless AP in accordance with the first wireless AP and the second wireless AP belonging to a same group.

Clause 52: The first wireless AP of any of clauses 35 through 51, where the processing system is further configured to cause the first wireless AP to: propagate the timing information associated with the communication periods of the second wireless AP and honor the communication periods of the second wireless AP and in accordance with one or more communication parameters satisfying one or more criteria.

Clause 53: The first wireless AP of clause 52, where the one or more communication parameters are received via the one or more frames or are selected by the first wireless AP, or any combination thereof.

Clause 54: The first wireless AP of any of clauses 35 through 53, where the processing system is further configured to cause the first wireless AP to: transmit, to a third wireless AP, a first frame including a request for information indicative of a set of most recent medium access schedules; and receive, from the third wireless AP, a second frame including the information indicative of the set of most recent medium access schedules, the set of most recent medium access schedules including one or more first medium access schedules of the third wireless AP and one or more second medium access schedules of one or more other wireless APs propagated by the third wireless AP.

Clause 55: The first wireless AP of any of clauses 35 through 54, where the value is a hop count associated with the multi-hop propagation of the timing information.

Clause 56: The first wireless AP of any of clauses 35 through 55, where the first wireless AP and the second wireless AP are physically separated wireless APs.

Clause 57: A first wireless AP, including: a processing system that includes processor circuitry and memory circuitry that stores code, the processing system configured to cause the first wireless AP to: generate one or more frames to include timing information associated with communication periods of the first wireless AP and a value associated with a multi-hop propagation of the timing information; and transmit, via the one or more frames, the timing information and the value associated with the multi-hop propagation of the timing information.

Clause 58: The first wireless AP of clause 57, where, to transmit the value associated with the multi-hop propagation of the timing information, the processing system is further configured to cause the first wireless AP to: transmit the value via a broadcast target wake time (TWT) identifier (ID) field.

Clause 59: The first wireless AP of clause 58, where the broadcast TWT ID field is associated with the value in accordance with a TWT schedule information subfield being set to a second value.

Clause 60: The first wireless AP of any of clauses 58 through 59, where the value is indicative of a presence, within a TWT element associated with the broadcast TWT ID field, of one or more additional fields associated with the multi-hop propagation of the timing information.

Clause 61: The first wireless AP of clause 60, where the one or more additional fields include a group ID field, a basic service set (BSS) color field, an acceptable interference field, a field indicative of a list of other AP IDs, or any combination thereof, the one or more additional fields to be propagated with the timing information.

Clause 62: The first wireless AP of any of clauses 57 through 61, where, to transmit the value associated with the multi-hop propagation of the timing information, the processing system is further configured to cause the first wireless AP to: transmit the value via a hop count field of a frame or element dedicated to conveying information associated with the multi-hop propagation of the timing information.

Clause 63: The first wireless AP of clause 62, where the processing system is further configured to cause the first wireless AP to: transmit, via the frame or element, one or more additional fields associated with the multi-hop propagation of the timing information.

Clause 64: The first wireless AP of clause 63, where the one or more additional fields include a schedule start time field, a periodicity field, a service period duration field, a persistence field, a group ID field, a basic service set (BSS) color field, a transmission parameter field, or any combination thereof.

Clause 65: The first wireless AP of any of clauses 57 through 64, where the processing system is further configured to cause the first wireless AP to: transmit, via the one or more frames, information indicative of a group to which the first wireless AP belongs, where one or more other wireless APs are expected to propagate the timing information associated with the communication periods of the first wireless AP and honor the communication periods of the first wireless AP in accordance with the first wireless AP and the one or more other wireless APs belonging to a same group.

Clause 66: The first wireless AP of any of clauses 57 through 65, where the processing system is further configured to cause the first wireless AP to: transmit, via the one or more frames, information indicative of one or more communication parameters, where one or more other wireless APs are expected to propagate the timing information associated with the communication periods of the first wireless AP and honor the communication periods of the first wireless AP in accordance with the one or more communication parameters satisfying one or more criteria at the one or more other wireless APs.

Clause 67: The first wireless AP of any of clauses 57 through 66, where the processing system is further configured to cause the first wireless AP to: receive, from a second wireless AP, a first frame including a request for information indicative of a set of most recent medium access schedules; and transmit, to at least the second wireless AP, a second frame including the information indicative of the set of most recent medium access schedules, the set of most recent medium access schedules including one or more first medium access schedules of the first wireless AP and one or more second medium access schedules of one or more other wireless APs propagated by the first wireless AP.

Clause 68: The first wireless AP of any of clauses 57 through 67, where the value is a hop count associated with the multi-hop propagation of the timing information.

Clause 69: A first wireless AP, including one or more memories storing processor-executable code, and one or more processors coupled with the one or more memories and individually or collectively operable to execute the code to cause the first wireless AP to perform a method of any of clauses 1 through 22.

Clause 70: A first wireless AP, including at least one means for performing a method of any of clauses 1 through 22.

Clause 71: A non-transitory computer-readable medium storing code for wireless communication, the code including instructions executable by one or more processors, individually or collectively, to perform a method of any of clauses 1 through 22.

Clause 72: A first wireless AP, including one or more memories storing processor-executable code, and one or more processors coupled with the one or more memories and individually or collectively operable to execute the code to cause the first wireless AP to perform a method of any of clauses 23 through 34.

Clause 73: A first wireless AP, including at least one means for performing a method of any of clauses 23 through 34.

Clause 74: A non-transitory computer-readable medium storing code for wireless communication, the code including instructions executable by one or more processors, individually or collectively, to perform a method of any of clauses 23 through 34.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless access point (AP), comprising:
a processing system that includes processor circuitry and memory circuitry that stores code, the processing system configured to cause the first wireless AP to:
receive, via one or more frames, timing information associated with communication periods of a second wireless AP and a value associated with a multi-hop propagation of the timing information; and
selectively transmit, via a frame of the first wireless AP, the timing information associated with the communication periods of the second wireless AP in accordance with the value.

2. The first wireless AP of claim 1, wherein, to receive the value associated with the multi-hop propagation of the timing information, the processing system is further configured to cause the first wireless AP to:
receive the value via a broadcast target wake time (TWT) identifier (ID) field.

3. The first wireless AP of claim 2, wherein the broadcast TWT ID field is associated with the value in accordance with a TWT schedule information subfield being set to a second value.

4. The first wireless AP of claim 2, wherein the value is indicative of a presence, within a TWT element associated with the broadcast TWT ID field, of one or more additional fields associated with the multi-hop propagation of the timing information.

5. The first wireless AP of claim 4, wherein the one or more additional fields include a group ID field, a basic service set (BSS) color field, an acceptable interference field, a field indicative of a list of other AP IDs, or any combination thereof, the one or more additional fields to be propagated with the timing information.

6. The first wireless AP of claim 1, wherein, to receive the value associated with the multi-hop propagation of the timing information, the processing system is further configured to cause the first wireless AP to:
receive the value via a hop count field of a frame or element dedicated to conveying information associated with the multi-hop propagation of the timing information.

7. The first wireless AP of claim 6, wherein the processing system is further configured to cause the first wireless AP to:
receive, via the frame or element, one or more additional fields associated with the multi-hop propagation of the timing information.

8. The first wireless AP of claim 7, wherein the one or more additional fields include a schedule start time field, a periodicity field, a service period duration field, a persistence field, a group ID field, a basic service set (BSS) color field, a transmission parameter field, or any combination thereof, the one or more additional fields to be propagated with the timing information.

9. The first wireless AP of claim 1, wherein, to selectively transmit the timing information, the processing system is further configured to cause the first wireless AP to:
transmit the timing information in association with the value indicating that the first wireless AP is to propagate the timing information.

10. The first wireless AP of claim 9, wherein the processing system is further configured to cause the first wireless AP to:
transmit an updated value in association with transmitting the timing information via the frame of the first wireless AP, wherein the updated value is associated with an increment or a decrement of the value.

11. The first wireless AP of claim 10, wherein the updated value is transmitted via the frame or a second frame of the first wireless AP.

12. The first wireless AP of claim 1, wherein the processing system is further configured to cause the first wireless AP to:
transmit scheduling information to one or more wireless stations (STAs) associated with the first wireless AP in accordance with the value, wherein the value is further associated with a coordination status between the first wireless AP and the second wireless AP.

13. The first wireless AP of claim 12, wherein the processing system is further configured to cause the first wireless AP to:
communicate with the one or more wireless STAs outside of the communication periods of the second wireless AP in accordance with the value indicating a first coordination status, the first coordination status being associated with an expectation to honor the communication periods of the second wireless AP; or
communicate with the one or more wireless STAs during at least a portion of the communication periods of the second wireless AP in accordance with the value indicating a second coordination status, the second coordination status being associated with no expectation to honor the communication periods of the second wireless AP.

14. A first wireless access point (AP), comprising:
a processing system that includes processor circuitry and memory circuitry that stores code, the processing system configured to cause the first wireless AP to:
generate one or more frames to include timing information associated with communication periods of the first wireless AP and a value associated with a multi-hop propagation of the timing information; and
transmit, via the one or more frames, the timing information and the value associated with the multi-hop propagation of the timing information.

15. The first wireless AP of claim 14, wherein the processing system is further configured to cause the first wireless AP to:
transmit, via the one or more frames, information indicative of a group to which the first wireless AP belongs, wherein one or more other wireless APs are expected to propagate the timing information associated with the communication periods of the first wireless AP and honor the communication periods of the first wireless AP in accordance with the first wireless AP and the one or more other wireless APs belonging to a same group.

16. The first wireless AP of claim 14, wherein the processing system is further configured to cause the first wireless AP to:
transmit, via the one or more frames, information indicative of one or more communication parameters, wherein one or more other wireless APs are expected to propagate the timing information associated with the communication periods of the first wireless AP and honor the communication periods of the first wireless AP in accordance with the one or more communication parameters satisfying one or more criteria at the one or more other wireless APs.

17. A method for wireless communication by a first wireless access point (AP), comprising:
receiving, via one or more frames, timing information associated with communication periods of a second wireless AP and a value associated with a multi-hop propagation of the timing information; and
selectively transmitting, via a frame of the first wireless AP, the timing information associated with the communication periods of the second wireless AP in accordance with the value.

18. The method of claim 17, further comprising:
receiving, via one or more second frames, the timing information associated with the communication periods of the second wireless AP and a second value associated with the multi-hop propagation of the timing information; and
selecting the value instead of the second value in accordance with one or more criteria.

19. The method of claim 18, wherein selecting the value instead of the second value further comprises:
selecting the value in accordance with the value being relatively lower than the second value;
selecting the value in accordance with the value being relatively higher than the second value; or
selecting the value in accordance with the one or more frames being of the second wireless AP.

20. The method of claim 17, further comprising:
transmitting, to a third wireless AP, a first frame including a request for information indicative of a set of most recent medium access schedules; and
receiving, from the third wireless AP, a second frame including the information indicative of the set of most recent medium access schedules, the set of most recent medium access schedules including one or more first medium access schedules of the third wireless AP and one or more second medium access schedules of one or more other wireless APs propagated by the third wireless AP.
